(19) United States
(12) Patent Application Publication
(10) Pub. No.: US 2024/0314027 A1
(43) Pub. Date: Sep. 19, 2024

(54) SUPPORTING MULTIPLE DCCF DEPLOYMENT

(71) Applicant: Telefonaktiebolaget LM Ericsson (publ), Stockholm (SE)

(72) Inventors: Zhang FU, Stockholm (SE); Miguel Angel GARCIA MARTIN, Madrid (ES); Ulf MATTSSON, Kungsbacka (SE)

(21) Appl. No.: 18/262,266

(22) PCT Filed: Feb. 18, 2022
(86) PCT No.: PCT/IB2022/051474

§ 371 Date: Jul. 20, 2023

Related U.S. Application Data
(60) Provisional application No. 63/150,960, filed on Feb. 18, 2021.

(51) Int. Cl. H04L 41/0806; H04L 41/0853

(52) U.S. Cl. CPC H04L 41/0806; H04L 41/0853

(57) ABSTRACT

A method implemented in a data collector node (DCN) is described. The DCN is configured to communicate at least with a network node and a data source node (DSN). The method includes determining a data collection coordination. The determined data collection coordination is associated with the DSN and includes determining whether any DCN is registered as a data collection coordinator of for the DSN. Upon determining there is no registered data collection coordinator of for the DSN, a request to register as the data collection coordinator of the DSN is transmitted to the network node. Upon determining the DCN is itself the data collection coordinator, data collection from the DSN is coordinated. Further, upon determining a second DCN is registered as the data collection coordinator, a subscription request for data collection from the DSN is transmitted to the second DCN.

### TECHNICAL FIELD

This disclosure relates to a method and system for supporting multiple data collection coordination function (DCCF) deployment.

### BACKGROUND

### NF Service Consumer—NF Service Producer Interactions Defined in 5GS

The following interactions may be defined in clause 7.1.2 in the 3^{rd} Generation Partnership Project (3GPP) Technical Specification (TS) 23.501 for network function (NF) service Consumer and NF service Producer interactions, as follows e.g.:

The end-to-end interaction between two NFs (Consumer and Producer) within this NF service framework follows two mechanisms, irrespective of whether Direct Communication or Indirect Communication is used:

“Request-response”: A Control Plane NF_B (NF Service Producer) is requested by another Control Plane NF_A (NF Service Consumer) to provide a certain NF service, which either performs an action or provides information or both. NF_B provides an NF service based on the request by NF_A. In order to fulfil the request, NF_B may in turn consume NF services from other NFs. In Request-response mechanism, communication is one to one between two NFs (consumer and producer) and a one-time response from the producer to a request from the consumer is expected within a certain timeframe. The NF Service Producer may also add a Binding Indication (see 3GPP TS 23.501 clause 6.3.1.0) in the Response, which may be used by the NF Service Consumer to select suitable NF service producer instance(s) for subsequent requests. For indirect communication, the NF Service Consumer copies the Binding Indication into the Routing Binding indication, that is included in subsequent requests, to be used by a Service Communication Proxy (SCP) to discover a suitable NF service producer instance(s).

FIG. 1 (e.g., FIG. 7.1.2-1: “Request-response” NF Service illustration in 3GPP TS 23.501) illustrates one or more of the following steps:
1. “Subscribe-Notify”: A Control Plane NF_A (NF Service Consumer) subscribes to NF Service offered by another Control Plane NF_B (NF Service Producer). Multiple Control Plane NFs may subscribe to the same Control Plane NF Service. NF_B notifies the results of this NF service to the interested NF(s) that subscribed to this NF service. The subscription request may include the notification endpoint, i.e., Notification Target Address) and a Notification Correlation identifier (ID) (e.g., the notification universal resource locator (URL)) of the NF Service Consumer to which the event notification from the NF Service Producer should be sent to.

NOTE 1: The notification endpoint URL can contain both the notification endpoint and the Notification Correlation ID.
2. The NF Service Consumer may add a Binding Indication (see clause 6.3.1.0 in 3GPP TS 23.501) in the subscribe request, which may be used by the NF Service Producer to discover a suitable notification endpoint. For indirect communication, the NF Service Producer copies the Binding Indication into the Routing Binding Indication, that is included in the response, to be used by the SCP to discover a suitable notification target. The NF Service Producer may also add a Binding Indication (see clause 6.3.1.0) in the subscribe response, which may be used by the NF Service Consumer (or SCP) to select suitable NF service producer instance(s) or NF producer service instance. In addition, the subscription request may include notification request for periodic updates or notification triggered through certain events (e.g., the information requested gets changed, reaches certain threshold etc.). The subscription for notification can be done through one of the following ways:
   Explicit subscription: A separate request/response exchange between the NF Service Consumer and the NF Service Producer; or
   Implicit subscription: The subscription for notification is included as part of another NF service operation of the same NF Service; or
   Default notification endpoint: Registration of a notification endpoint for each type of notification the NF consumer is interested to receive, as a NF service parameter with the NRF during the NF and NF service Registration procedure as specified in 3GPP TS 23.502 clause 4.17.1.
3. The NF Service Consumer may also add a Binding Indication (see clause 6.3.1.0 in 3GPP TS 23.501) in the response to the notification request, which may be used by the NF Service Producer to discover a suitable notification endpoint. For indirect communication, the NF Service Producer copies the Binding Indication into the Routing Binding indication that is included in subsequent notification requests. The binding indication is then used by the SCP to discover a suitable notification target.

FIG. 2 (e.g., FIG. 7.1.2-2: “Subscribe-Notify” NF Service illustration 1 in 3GPP TS 23.501) illustrates one or more of the following:

A Control Plane NF_A may also subscribe to NF Service offered by Control Plane NF_B on behalf of Control Plane NF_C, i.e., it requests the NF Service Producer to send the event notification to another consumer(s). In this case, NF_A includes the notification endpoint, i.e., Notification Target Address) and a Notification Correlation ID, of the NF_C in the subscription request. NF_A may also additionally include the notification endpoint and a Notification Correlation ID of NF A associated with subscription change related Event ID(s), e.g., Subscription Correlation ID Change, in the subscription request, so that NF_A can receive the notification of the subscription change related event. The NF_A may add Binding Indication (see clause 6.3.1.0) in the subscribe request.

FIG. 3 (e.g., FIG. 7.1.2-3: “Subscribe-Notify” NF Service illustration 2 in TS 23.501) illustrates one or more of the following:

Routing of the messages for the NF interaction mechanisms above may be direct, as shown in the FIGS. 7.1.2-1 to 7.1.2-3, or indirect. In the case of Indirect Communication, a SCP is employed by the NF service consumer. The SCP routes messages between NF service consumers and NF service producers based on the Routing Binding Indication if available. The SCP may perform discovery and associated selection of the NF service producer on behalf of a NF service consumer. FIG. 4 (e.g., FIG. 7.1.2-4 in 3GPP TS 23.501) shows the principle for a request-response interaction, and FIG. 5 (e.g., FIG. 7.1.2-5 in 3GPP TS 23.501) shows an example of a subscribe-notify interaction. FIG. 5/NOTE: The subscribe request and notify request can be routed by different SCPs.

### Background for DCCF (Data Collection Coordination Function)

The Framework includes the following components:
1. Data Collection Coordination Function (DCCF).
2. with optional DCCF Adaptor (DA).
3. Messaging Framework (for Data Forwarding and Replication),
4. with optional Adaptors (3CA/Consumer Adaptor and 3PA/Producer Adaptor) to isolate the Messaging Framework protocol from the Data Source and the Data Consumer.

The interfaces subject to 3GPP standardization are NF consumer-DCCF, DCCF-NF producer, DCCF-DA, NF consumer 3CA and NF producer-3PA. It is expected that 3PA can re-use existing interfaces and services.

FIG. 6 (e.g., FIG. 6.9.2.1-1 in TS 23.501) illustrates an example Data Management Framework (“Framework”) for 3GPP 5th Generation Core (5CG), as follows:

NOTE 1: When Data Source is Operations and Management (OA&M), OA&M services, as defined by SA working group 5 (WG5), are reused.

NOTE 2: The 3PA may alternatively be standalone or combined with the Data Source. A 3PA is not needed if the Data Source natively supports the message bus protocol.

NOTE 3: The 3CA may alternatively be standalone or combined with the Data Consumer. A 3CA is not needed if the Data Consumer natively supports the message bus protocol.

NOTE 4: The DA may alternatively be standalone or combined with the DCCF. A DA is not needed if the DCCF natively supports the message bus protocol.

NOTE 5: The intended Consumer of Data Management Framework services is a network data analytics function (NWDAF) Analytics Function or an NF requesting analytics, but as with other NF services, nothing precludes other Consumers (NFs) from using it.

NOTE 6: NWDAFs co-located with NFs can also be consumers of Data Management Framework services, thus avoiding duplicate data collection from the NFs, e.g., by co-located NWDAF and other NWDAFs.

NOTE 7: Adaptors (3CA, 3PA and DA) are not expected to be standardized by 3GPP, only the interface between 3GPP entities and the adaptors is under 3GPP scope.

### Data Collection Coordination Function (DCCF)

The DCCF is a control-plane function that coordinates data collection and triggers data delivery to Data Consumers. A DCCF may support multiple Data Sources, Data Consumers, and Message Frameworks. However, to prevent duplicate data collection, each Data Source is associated with only one DCCF.

The DCCF provides the 3GPP defined Ndccf_DataExposure Service to Data Consumers (e.g., NWDAF), and uses the services of Data Sources (e.g., 3GPP NF) to obtain data. FIG. 6 (e.g., FIG. 6.9.2.1-1 in 3GPP TS 23.501) shows one DCCF for the 5GC. There can be multiple instances of the DCCF, e.g., for network slices, geographic regions where Data Sources reside or for different Data Source types. A DCCF needed by a Consumer can be discovered using the NRF as described below.

NOTE 1: the DCCF may be aware of the Data Sources it is coordinating. The network repository function (NRF) and unified data management (UDM) may provide the DCCF with the identity of 5GC Data Sources (e.g., an access and mobility management function (AMF) serving a user equipment (UE)). The DCCF also hides Data Source life cycle events and changes of entity serving a UE from the Data Consumer. For example, if an NF Data Source that serves a UE changes because of a life-cycle event, the NRF may notify a DCCF that has previously subscribed to NRF event notifications. The DCCF may also use the UDM to learn the new (UE, NF) association, thus making the change of the NF serving a WD, e.g., UE, transparent to the Data Consumer.

NOTE 2: In this release, if there is more than one DCCF, they may coordinate the collection and distribution of data for orthogonal sets of Data Sources. In this case, a Data Consumer discovers the DCCF for the data it needs, and the DCCF and the Message Framework delivers the data from the proscribed set of Data Sources. If a DCCF cannot serve a request from a Data Consumer, the DCCF may query the NRF to determine an acceptable DCCF and redirect the query accordingly.

NOTE 3: DCCF is not intended to support aggregation of analytics data across multiple NWDAFs. However, the DCCF keeps track of Consumer Requests to the NWDAF “Data Source”, and hence knows what analytics are being produced by an NWDAF. Therefore, the Data Management Framework can be used by a Consumer (which could be an NWDAF) that consumes (e.g., aggregates) analytics data from one or more NWDAF acting as a “Data Source” or from the Data Repository. The NWDAF acting as “Data Source” supplies Analytics output as “Data”, using the services defined in 3GPP TS 23.288 clause 7 (subscribe/notify), similar to any other NF

The DCCF may one or more of:
Receive data requests from Data Consumers via the Ndccf_DataExposure service. A Data Consumer may be a NWDAF Analytics function (3GPP Release 17 (Rel-17) NWDAF), and the contents of the service requests are based on Rel-16 services (e.g., AMF or session management function (SMF) event exposure). The DCCF service may provide additional functionality, for example, to allow one request that requires multiple Data Sources (e.g., AMF and SMF) and allow formatting and processing of notifications according to conditions specified by the consumer as described in the bullet list below.
If the Data Source is not specified in the Data Request, the DCCF determines the Data Source that can provide the data requested by the Data Consumer (e.g., an event requested by the Data Consumer for NF event exposure). For example, if the request is for UE specific data, the DCCF may query the NRF/UDM/BSF to determine which NF instance is serving the UE, as described in 3GPP TS 23.288 Table 6.2.2.1-2: NF Services consumed by NWDAF to determine which NF instances are serving a UE.
If the Data Source is specified in the Data Request (e.g., the data consumer is configured with the data sources), the DCCF checks whether the Data is already collected from the Data Source. If not, it will request the Data to the specified Data Source.
The DCCF checks if the Data Consumer is authorized to access DCCF services using the procedures specified in 3GPP TS 23.501 clause 7.1.4 “Network Function Service Authorization”.

NOTE 1: Additional authorization for Consumers to access data from a Data Source via the DCCF may be considered by SA working group 3 (WG3).
Determine if the requested data is currently being produced by any Data Source and sent to the Messaging Framework. If the requested data is not being produced, a new subscription/request is sent towards the Data Source to trigger a new data collection and the DCCF then subscribe with the messaging framework for the Consumer to receive future notifications. Similarly, when the last Data Consumer of a specific data does no longer wants data, the DCCF cancels data collection from the Data Source and from the messaging framework. This ensures that the Data Source is only producing the same data once when there are multiple Data Consumers and is not producing data that no Data Consumer needs.

The DCCF may determine if data is already being collected by maintaining a record of the prior requests it has made for data (e.g., via an Nnf_EventExposure service offered by the Data Source). If parameters in a prior request for data match those that are needed in a subsequent request, the DCCF may determine that the requested data is already being collected. The DCCF may then subscribe with the messaging framework for the new Consumer to receive future notifications.

Formatting conditions and Processing instructions requested by Data Consumers via the Ndccf_DataExposure service may be passed to the Messaging Framework via the Nda_Data_Management Service. The 3CA may then accordingly send notifications to the consumer. Formatting conditions determine when a notification is sent to the Consumer. For example, formatting may include one or more of:
Notification Event clubbing (buffering and sending of several notifications in one message).
A Notification Time Window (e.g., notifications are buffered and sent between 2 and 3 AM).
Cross event reference-based notification (when a subscribing NF is subscribing to multiple events (e.g., event X and event Y) the notification for an Event-X is buffered and reported only when the Event-Y occurs).
Consumer triggered Notification.
Exact time-based Notification without the event (Data is reported at an exact time, irrespective of event occurs or not. Example: every 30 min).
Mathematical calculation-based notification (e.g., Exponential time window: The first notification is sent after 5 min. The next notification is sent after 10 min, and the third is after 15 min etc.).

NOTE 2: The extent of formatting variations to be supported can be decided in the normative phase.

Processing instructions allow summarizing of notifications at 3CA to reduce the volume of data reported from the 3CA to the Data Consumer. This may be particularly useful when data from a Data Repository (historical data) is requested that comprises a large number of notifications. The type of processing is specified by the consumer and may result in joining the information from multiple notifications into a common report.

When the DCCF receives a request for historical data (e.g., an NWDAF requesting analytics previously generated by another NWDAF), the DCCF may trigger retrieval of the data from the Data Repository and make it available over the messaging framework.

The DCCF may also one or more of:
Manages subscription requests and cancellations to the Messaging Framework on behalf of Data Consumers. The DCCF may use a native Messaging Framework protocol or alternatively a 3GPP defined protocol with an adaptor that translates to the Messaging Framework protocol (as depicted in FIG. 6).
If standalone 3PAs and 3CAs are used, the DCCF maintains the (NF, 3PA) and (NF, 3CA) associations.

For DCCF discovery, the DCCF registers with the NRF and is discovered by Consumers or the SCP using the registration and discovery procedures defined for the Network Function Service Framework in 3GPP TS 23.502, clause 4.17. The DCCF profile in the NRF may specify one or more of:
The slices (single network slice selection assistance information (S-NSSAIs)) that the DCCF Supports.
The Source Types that a DCCF coordinates.
The serving area (e.g., list of tracking area identifiers (TAIs)) containing Data Sources that the DCCF coordinates.

Source Type may correspond to an NF Type (e.g., SMF, AMF, etc.), or different domains (e.g., OA&M). Hence a Consumer or SCP may request or select a DCCF according to the type of information it is requesting, the network slices it supports and its serving area.

NOTE 3: Additional DCCF Profile parameters can be considered during the normative stage.

### Messaging Framework

The Messaging Framework is not expected to be standardized by 3GPP. It contains Messaging Infrastructure that propagates event information and data (e.g., streaming and notifications) from Data Sources to Data Consumers. The Messaging Framework may support the pub-sub pattern, where data is published by producer adaptors (or data source if the data source natively supports the message bus protocol) and can be subscribed to by consumer adaptor (or data consumers if the data consumer natively supports the message bus protocol).

The Messaging Framework may support multiple event delivery mechanisms such as best effort or guaranteed delivery. For 3GPP purposes guaranteed delivery of events may be utilized.

The Messaging Framework may contain one or more Adaptors that translate between 3GPP defined protocols (e.g., 3GPP Release 16 (Rel-16) Nnwdaf_AnalyticsSubscription_Notify) and a Data Forwarding Protocol not specified by 3GPP. The Messaging Framework adaptors maintain subscription information, including formatting conditions and processing instructions received by the DA.

The Adaptor on the Producer side (3PA) allows any Source Data (e.g., from 3GPP Rel-16 OA&M or NF EventExposure) to be distributed via the framework without impact on the Data Source. The DCCF keeps track on the Adaptor instances. An Adaptor may be associated with specific NF types, manage one or more data Sources, and may be provisioned on the DCCF together with the sources it supports. If the Messaging Framework directly supports 3GPP interfaces, Adaptors may not be required.

### Procedures for Consumers and Producers Using 3CA and 3PA

An example procedure is given in FIG. 7 (e.g., FIG. 6.9.3-1 in 3GPP TS 23.501) for Data Collection & Distribution for Event Notifications (Subscribe/Notify). The procedure illustrates how the DCCF manages Data Sources so data are produced only once and how the DCCF interacts with the messaging framework so data are distributed to all subscribed Data Consumers. The procedure applies for consumers and producers using 3CA and 3PA, i.e., all steps are within 3GPP remit.

Data handled by the messaging framework is associated with an identifier. The example procedure in FIG. 7 assumes that the Messaging Framework uses a Pub/Sub model based on “Data Tags” (which could for example be a “Topic” in some message framework protocols). The 3PA can publishes to a “Data Tag” and a 3CA that wishes to receive the data subscribes to the “Data Tag”. Other options can also be supported. FIG. 7 illustrates one or more of the following steps:
1. Data Consumer-1 (e.g., NWDAF-1) sends a request for data to the DCCF. The message includes the Notification Target Address. The message may indicate whether the requested data should be sent to the Notification Target Address set to Data Consumer-1 and/or to other Consumers such as Data Repository. The Notification Correlation ID of the Consumer-1 is included in the request message and is used for notifications sent to Data Consumer-1 (e.g., in step 8).
2. If the request is for UE data, the DCCF may query the UDM/NRF/BSF to determine the NF serving the UE.
3. The DCCF determines the Data Source (e.g., AMF-1) that can provide the data and checks that the requested data is not already being collected.
4. The DCCF controls the message bus and the adaptors so the notifications traverse the messaging framework. The subscription to the DA includes a Notification Correlation ID of the 3PA and the Notification Correlation ID for Data Consumer-1 as received in step 1. The DA may associate these with a messaging framework. The 3PA is provided with its Notification Correlation ID and the “Data Tag”. The 3CA will be provided with the consumer's notification endpoint, the Notification_Correlation_ID of the Consumer and the “Data Tag”. The 3CA may then subscribe to the “Data Tag” in the messaging framework.
5. The DCCF sends a subscription request to a NF producer acting as a data source. The subscription includes the notification endpoint and Notification Correlation ID of the 3PA that is acting as the receiver for these notifications.
6. The Data Source acknowledges the request.
7. A Notification containing the Notification Correlation ID of the 3PA is sent to the 3PA after an event trigger at the Data Source. The 3PA publishes the data in the message framework. It may use “Data Tag” the associated with the Notification Correlation ID of the 3PA received in step 4.
8. When the data is published to the “Data Tag”, the Messaging Framework makes it available to all subscribed 3CA. In this case the only subscriber is a 3CA serving consumer-1. This 3CA maps the “Data Tag” to the Notification Correlation ID of the Data Consumer received in Step 4 (which was originally provided by Data Consumer-1) and sends the notification to the notification endpoint of Data Consumer-1.
9. Data Consumer-2 (e.g., NWDAF-2) sends a request for the same Data. The message may indicate whether the requested data should be sent to Data Consumer-2, and/or to other Consumers such as Data Repository. The Notification Correlation ID of Consumer-2 is included for notifications sent to Data Consumer-2.
10. The DCCF determines that the requested data is already being collected from a Data Source (e.g., AMF-1) and retrieves 3PA ID and the Notification Correlation ID of the 3PA.
11. The DCCF sends a subscription request to the Messaging Framework indicating that there is a new subscriber of the data. The subscribe message to the DA provides the 3PA ID, the 3PA Notification Correlation ID currently in use, and the Notification Correlation ID for Data Consumer-2 as received in step 9. The DA selects the existing “Data Tag” corresponding to the 3PA information and sends the 3CA Consumer-2's notification endpoint, the Notification_Correlation_ID of Consumer-2 and the “Data Tag”. The 3CA may then subscribe to the “Data Tag” in the messaging framework.

NOTE: The 3CA for Consumer-2 may be different or the same from 3CA for Consumer-1.
12. After an event is triggered in the data source, a Notification is sent to the 3PA and 3PA publishes the data to the corresponding “Data Tag” on the Messaging Framework.
13-14. When the data is published to the “Data Tag” the Messaging Framework makes it available to the subscribed 3CAs. In this case the 3CAs serving consumer-1 and consumer-2 receive the data and send the notifications to the notification endpoints of Data Consumer-1 and Data Consumer-2 using the Notification Correlation ID of Consumer-1 and Consumer-2, respectively. A Data Repository also receives notifications if it has subscribed via the DCCF.

### SUMMARY

Some embodiments advantageously provide a method and system for multiple data collection coordination function (DCCF) deployment.

In some embodiments, a method implemented in a data collector node (DCN) includes initiating data collection coordination for a data source node (DSN), the initiating comprising at least one of: sending a request to a network node to register with the network node as a data collection coordinator for the DSN; and subscribing to the DSN to initiate data collection from the DSN; and optionally, receiving data associated with the DSN based on whether the DSN is associated with a second DCN and/or any other DCN.

In one embodiment, a method implemented in a network node includes receiving a request from a data collector node (DCN) to register with the network node as a data collection coordinator for a data source node (DSN); and determining whether the DSN is associated with a second DCN and/or any other DCN.

In one embodiment, a method implemented in a data source node (DSN) includes receiving a subscription from a first data collector node (DCN) to initiate data collection from the DSN; and determining whether the DSN is associated with a second DCN and/or any other DCN.

According to one aspect, a method implemented in a DCN is described. The DCN is configured to communicate at least with a network node and a DSN. The method includes determining a data collection coordination. The determined data collection coordination is associated with the DSN and comprises determining whether any DCN is registered as a data collection coordinator for the DSN. Upon determining there is no registered data collection coordinator for the DSN, a request to register as the data collection coordinator of the DSN is transmitted to the network node. Upon determining the DCN is itself the data collection coordinator, data collection from the DSN is coordinated. Further, upon determining a second DCN is registered as the data collection coordinator, a subscription request for data collection from the DSN is transmitted to the second DCN.

In some embodiments, determining whether any DCN is registered as the data collection coordinator for the DSN comprises transmitting to the network node a request to check if any DCN is registered for the DSN.

In some other embodiments, the network node is a node implementing at least one of a user data management function and a network resource function.

In one embodiment, the network node is a node implementing a binding support function (BSF).

In another embodiment, the request to register as the data collection coordinator comprises a first identification of the DSN.

In some embodiments, determining the DCN is itself the data collection coordinator comprises receiving a first response from the network node 14 indicating the DCN itself is the data collection coordinator for the DSN.

In some other embodiments, the method further comprises receiving from a third DCN a subscription request for data associated with the DSN for which the DCN is the data collection coordinator.

In one embodiment, determining the second DCN is registered as the data collection coordinator comprises receiving a first response from the network node indicating the second DCN is the data collection coordinator for the DSN.

In another embodiment, the request to register as the data collection coordinator of the DSN causes a mapping to be maintained at the network node. The mapping is between at least one parameter associated with the DCN and at least another parameter associated with the DSN.

In some embodiments, the DCN comprises a data collection coordination function (DCCF), the network node comprises a unified data repository, and the DSN comprises a network function (NF).

According to another aspect, a data collector node (DCN) is described. The DCN is configured to communicate at least with a network node and a data source node (DSN), the DCN includes processing circuitry configured to determine a data collection coordination. The determined data collection coordination is associated with the DSN. The processing circuitry is configured to determine the data collection coordination by being further configured to determine whether any DCN is registered as a data collection coordinator for the DSN. Upon determining there is no registered data collection coordinator for the DSN, a request to register as the data collection coordinator of the DSN is transmitted to the network node. Upon determining the DCN is itself the data collection coordinator, data collection from the DSN is coordinated. Further, upon determining a second DCN is registered as the data collection coordinator, a subscription request for data collection from the DSN is transmitted to the second DCN.

In some embodiments, the processing circuitry is further configured to determine whether any DCN is registered as the data collection coordinator for the DSN by being further configured to cause the DCN to transmit to the network node a request to check if any DCN is registered for the DSN.

In some other embodiments, the network node is a node implementing at least one of a user data management function and a network resource function.

In one embodiment, the network node is a node implementing a binding support function (BSF).

In another embodiment, the request to register as the data collection coordinator comprises a first identification of the DSN.

In some embodiments, the processing circuitry is further configured to determine the DCN is itself the data collection coordinator by being further configured to cause the DCN to receive a first response from the network node indicating the DCN itself is the data collection coordinator for the DSN.

In some other embodiments, the processing circuitry is further configured to cause the DCN to receive from a third DCN a subscription request for data associated with the DSN for which the DCN is the data collection coordinator.

In one embodiment, the processing circuitry is further configured to determine the second DCN is registered as the data collection coordinator by being further configured to cause the DCN to receive a first response from the network node indicating the second DCN is the data collection coordinator for the DSN.

In another embodiment, the request to register as the data collection coordinator of the DSN causes a mapping to be maintained at the network node. The mapping is between at least one parameter associated with the DCN and at least another parameter associated with the DSN.

In some embodiments, the DCN comprises a data collection coordination function (DCCF), the network node comprises a unified data repository, and the DSN comprises a network function (NF).

According to one aspect, a method implemented in a network node configured to communicate with at least one data collector node (DCN). The method includes: receiving a request from the DCN to check if any DCN is registered as a data collection coordinator for the DSN; and receiving a registration request from the DCN to register with the network node as a coordinator node for the DSN when no DCN has registered as the data collection coordinator for the DSN.

In some embodiments, the method further includes determining whether any DCN, including the DCN transmitting the request, is registered as the data collection coordinator for the DSN.

In some other embodiments, the request comprises a first identification of the DSN.

In one embodiment, the method further includes transmitting a response to the DCN indicating whether one of: no data collection coordinator is registered for the DSN; and at least one data collection coordinator is registered for the DSN.

In another embodiment, the at least one data collection coordinator indicates the requesting DCN is already the data collection coordinator for the DSN.

In some embodiments, the received registration request causes a mapping to be maintained at the network node. The mapping is between at least one parameter associated with the DCN and at least another parameter associated with the DSN.

In some other embodiments, the at least another parameter associated with the DSN is a first identification of the DSN, and the at least one parameter associated with the DCN is a second identification of the DCN.

In one embodiment, when the response indicates at least one data collection coordinator is registered for the DSN and the at least one data collection coordinator is a second DCN, the response causes the DCN to transmit to the second DCN a subscription request for data collection from the DSN.

In another embodiment, the DCN comprises a data collection coordination function (DCCF), the network node comprises at least one of a unified data management (UDM), a network repository function (NRF), a unified data repository, and a binding support function (BSF), and the DSN comprises a network function.

According to another aspect, a network node configured to communicate with at least one data collector node (DCN) is described. The network node comprises processing circuitry configured to cause the network node to receive a request from the DCN to check if any DCN is registered as a data collection coordinator for the DSN; and receive a registration request from the DCN to register with the network node as a coordinator node for the DSN when no DCN has registered as the data collection coordinator for the DSN.

In some embodiments, the processing circuitry is further configured to determine whether any DCN, including the DCN transmitting the request, is registered as the data collection coordinator for the DSN.

In some other embodiments, the request comprises a first identification of the DSN.

In one embodiment, the processing circuitry is further configured to cause the network node to transmit a response to the DCN indicating whether one of: no data collection coordinator is registered for the DSN; and at least one data collection coordinator is registered for the DSN.

In another embodiment, the at least one data collection coordinator indicates the requesting DCN is already the data collection coordinator for the DSN. In some embodiments, the received registration request causes a mapping to be maintained at the network node. The mapping is between at least one parameter associated with the DCN and at least another parameter associated with the DSN.

In some other embodiments, the at least another parameter associated with the DSN is a first identification of the DSN, and the at least one parameter associated with the DCN is a second identification of the DCN.

In one embodiment, when the response indicates at least one data collection coordinator is registered for the DSN and the at least one data collection coordinator is a second DCN, the response causes the DCN to transmit to the second DCN a subscription request for data collection from the DSN.

In another embodiment, the DCN comprises a data collection coordination function (DCCF), the network node comprises at least one of a unified data management (UDM), a network repository function (NRF), a unified data repository, and a binding support function (BSF), and the DSN comprises a network function.

According to one aspect, a method implemented in a data source node (DSN) is described. The DSN is configured to communicate at least with a data collector node (DCN) and a network node. The method comprises selecting the DCN as a data collection coordinator for the DSN based on a first event exposure subscription from the DCN and subscribing for a status report of the DCN at the network node.

In some embodiments, the method further includes at least one of: transmitting a response based on the first event exposure subscription, where the response indicates the DSN has selected the DCN as the data collection coordinator for the DSN; and transmitting another response based on a second event exposure subscription from another DCN when the DCN has already been selected as the data collection coordinator for the DSN. The second response indicates the DSN has rejected the second event exposure subscription.

In some other embodiments, the DCN comprises a data collection coordination function DCCF the network node comprises at least one of a unified data management, a network repository function, a unified data repository, and a binding support function, and the DSN comprises a network function (NF).

In one embodiment, the method further includes receiving the first event exposure subscription from the DCN; and registering, in the network node, the DCN as the data collection coordinator for the DSN when the DSN receives the first event exposure subscription from the DCN.

According to another aspect, a data source node (DSN) is described. The DSN is configured to communicate at least with a data collector node (DCN) and a network node. The DSN comprises processing circuitry configured to select the DCN (12) as a data collection coordinator for the DSN based on a first event exposure subscription from the DCN; and subscribe for a status report of the DCN at the network node.

In some embodiments, the processing circuitry is further configured to cause the DSN to at least one of: transmit a response based on the first event exposure subscription, where the response indicates the DSN has selected the DCN as the data collection coordinator for the DSN; and transmit another response based on a second event exposure subscription from another DCN when the DCN has already been selected as the data collection coordinator for the DSN. The second response indicates the DSN has rejected the second event exposure subscription.

In some other embodiments, the DCN comprises a data collection coordination function DCCF the network node comprises at least one of a unified data management, a network repository function, a unified data repository, and a binding support function, and the DSN comprises a network function (NF).

In one embodiment, the processing circuitry is further configured to cause the DSN to receive the first event exposure subscription from the DCN; and register, in the network node, the DCN as the data collection coordinator for the DSN when the DSN receives the first event exposure subscription from the DCN.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example Request-response NF Service illustration;

FIG. 2 shows an example Subscribe-Notify NF Service illustration;

FIG. 3 shows an example Subscribe-Notify NF Service illustration;

FIG. 4 shows an example Request response using Indirect Communication;

FIG. 5 shows an example Subscribe-Notify using Indirect Communication;

FIG. 6 shows an example Data Management Framework for 5GC;

FIG. 7 shows an example Data Collection & Distribution for Event Notifications (Subscribe/Notify);

FIG. 8 illustrates an example system architecture according to some embodiments of the present disclosure;

FIG. 9 illustrates yet another example system architecture and example hardware arrangements for devices in the system, according to some embodiments of the present disclosure;

FIG. 10 is a flowchart of an example process in a requestor according to some embodiments of the present disclosure;

FIG. 11 is a flowchart of an example process a request obtainer according to some embodiments of the present disclosure;

FIG. 12 is a flowchart of an example process a provider according to some embodiments of the present disclosure;

FIG. 13 is a flowchart of another example process in a requestor according to some embodiments of the present disclosure;

FIG. 14 is a flowchart of another example process a request obtainer according to some embodiments of the present disclosure;

FIG. 15 is a flowchart of another example process a provider according to some embodiments of the present disclosure;

FIG. 16 illustrates an example call flow diagram according to some embodiments of the present disclosure; and

FIG. 17 illustrates an example call flow diagram according to some embodiments of the present disclosure.

### DETAILED DESCRIPTION

When Multiple DCCFs are deployed in the network, it may happen that different DCCFs receive data requests for the same data, then different DCCFs subscribe to the same data source for the same data, which is not efficient and may eliminate or reduce the benefit of using a Data Management Framework, since the same data may be sent multiple times for the subscriptions of different DCCFs.

It has been considered that, if there is more than one DCCF, they should coordinate the collection and distribution of data for orthogonal sets of Data Sources. In this case a Data Consumer discovers the DCCF for the data it needs, and the DCCF and the Message Framework delivers the data from the proscribed set of Data Sources. If a DCCF cannot serve a request from a Data Consumer it may query the NRF to determine an acceptable DCCF and redirect the query accordingly.

However, the above proposal may be based on configuration of the mapping between DCCF instances and data sources. Such proposal may complicate the deployment of DCCFs, and also for other NFs as data sources. For example, it may be that when a new DCCF starts, a network operation, administration and maintenance (OAM) node decide which or what types of data sources it coordinates; e.g., when a new NF (e.g., SMF) instance starts, OAM decides which DCCF will coordinate this NF instance.

The proposal may also complicate the NF registration updates to NRF. For example, if a DCCF instance will coordinate a new NF instance, then it may update its registration profile in the NRF; if a DCCF gives the responsibility of coordinating some data sources to a newly started DCCF, it may update its registration profile in the NRF, so that the data consumers can use that for DCCF discovery and selection.

Some embodiments of the present disclosure may provide arrangements that operate under the principle that the data collection from a specific NF is not coordinated by multiple DCCFs.

To achieve such target, some embodiments provide using a network node (NN), such as a UDM and/or NRF to register information about which DCCF instance is coordinating the data collection from which NF (e.g., data source NF). Such DCCF instance to NF relationship may be considered a dynamic relationship, in some embodiments. In particular, in some embodiments, when a DCCF subscribes to certain data from a data source NF, the DCCF may first check with a NN (e.g., UDM and/or NRF) as to whether there is already another DCCF coordinating the data collection from that data source NF. If not, then the DCCF may register itself in the NN (e.g., UDM and/or NRF) as the (e.g., single) data collection coordinator of that data source NF. Otherwise, in some embodiments, the DCCF may send the subscription request to the DCCF who is the coordinator of the data collection from that source NF.

Alternatively, or additionally, in some embodiments, each data source NF may choose the first DCCF who contacts/communicates with the data source NF as a coordinator of data collection from that data source NF. In some embodiments, if another DCCF contacts/communicates with that data source NF for a data subscription and/or to collect data, the data source NF may provide identifying information, such as an identifier (ID) of its coordinator DCCF in order to redirect such subsequent requesting DCCF to the DCCF that is currently coordinating the data collection from that data source NF.

Some embodiments of the present disclosure enable dynamic relationships between DCCFs and their corresponding data source NFs. Some embodiments may not impact the interaction between DCCF and NRF. Some embodiments may not impact the interaction between the data consumer and DCCF; thus, advantageously having little impact on the current SBA architecture.

Before describing in detail exemplary embodiments, it is noted that the embodiments reside primarily in combinations of apparatus components and processing steps related to supporting multiple data DCCF deployment. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the non-limiting terms wireless device (WD) or a user equipment (UE) are used interchangeably. The UE herein can be any type of wireless device capable of communicating with a network node or another UE over radio signals. In some embodiments, the UE may be an autonomous machine configured to communicate via IMS. The UE herein can by any type of communication device capable of communicating with another UE, an application server (AS), a network node, a server, an IMS NF or other IMS network node, via a wired connection and/or a wireless connection. The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

In some embodiments, the term “node” is used herein and can be any kind of network node, such as, a data collector node (e.g., DCCF) a Proxy-Call Session Control Function (P-CSCF) node, a mobility management node (e.g., Mobility Management Entity (MME) and/or Access and Mobility Function (AMF)), a gateway node (e.g., access gateway), a session management node (e.g., session management function (SMF) node), a user plane function (UPF) node, an AS node or any network node. In some embodiments, the network node may be, for example, a subscriber database node (e.g., unified data repository (UDR), home subscriber server (HSS)), a core network node, a Fifth Generation (5G) and/or New Radio (NR) network node, an Evolved Packet System (EPS) node, an Internet Protocol (IP) Multimedia Subsystem (IMS) node, an Serving-CSCF node, an Interrogating-CSCF node, a network repository function (NRF) node, a unified data management (UDM) node, binding support function (BSF), a Network Exposure Function (NEF) node, a home subscriber server (HSS) node, a home location register (HLR) node, etc.

In yet other embodiments, the network node may include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, one or more of the nodes described herein may be more generally considered and/or comprise a network function (NF) and may be referred to as a NF node. For example, the data source nodes described herein may be NF nodes.

In some embodiments, a Third Generation Partnership Project (3GPP) core network (e.g., 5GC) may include a Service Based Architecture (SBA) in which NFs (NFs) provide one or more services to one or more service consumers. This can be performed, for example, via Hyper Text Transfer Protocol/Representational State Transfer (HTTP/REST), application programming interfaces (APIs), etc. Generally, the various services may be considered self-contained functionalities that can be changed and modified in an isolated manner without affecting other services. Furthermore, the services may include various service operations, which may be more granular divisions of the overall service functionality. In some embodiments, in order to access a service, both the service name and the targeted service operation is to be indicated. The interactions between service consumers and service producers may be, for example, a “request/response” or “subscribe/notify” type or yet other types of interactions. In some embodiments, a network repository functions (NRF) may allow NFs to discover the services offered by other NFs, and Data Storage Functions (DSFs) may allow NFs to store its context. In some embodiments, the 5GC SBA model may provide e.g., modularity, reusability and/or self-containment of NFs, which may be compatible with virtualization technologies.

In some embodiments, one or more of the nodes described herein may be more generally considered and/or comprise an application function (AF) and may be referred to as an AF node. For example, the data consumer and data collector nodes described herein may be AF nodes.

In some embodiments, an AF may interact with a 3GPP core network (e.g., 5GC) to provide one or more of services. Based on operator deployment, an AF may be trusted by the operator to interact directly with relevant NFs (NFs). AFs not permitted by the operator to access directly the NFs may use, for example, an external exposure framework (e.g., via a network exposure function (NEF)) to interact with relevant NFs. In some embodiments, the AF may provide one or more services to a user/UE, in which, for example, a packet-based service data flow is provided to the user/UE, e.g., the streaming of video and/or audio data packets from a content provider to a subscriber of a mobile communications network. The AF may for example be attached to or part of the 3GPP Policy and Charging (PCC) architecture and may be specified in one or more particular 3GPP Technical Specifications.

In some embodiments, the various AF nodes and NF nodes that may be described herein may be referred to by their function names and/or more generally as network nodes and/or nodes.

A node described herein may include physical components, such as processors, allocated processing elements, or other computing hardware, computer memory, communication interfaces, and other supporting computing hardware. The node may use dedicated physical components, or the node may be allocated use of the physical components of another device, such as a computing device or resources of a datacenter, in which case the node may be said to be virtualized. A node may be associated with multiple physical components that may be located either in one location, or may be distributed across multiple locations.

As used herein, the terms “request” and “response” may be used interchangeably with “subscription” and “notification”, respectively. For example, a “request message” is used broadly to indicate e.g., a request message in a request-response interaction model and/or a subscription request in a subscription-notification interaction model. Similarly, “a message” or “response message” may indicate e.g., a response message in the request-response interaction model and/or a notification in the subscription-notification interaction model.

Note also that some embodiments of the present disclosure may be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, 3rd Generation Partnership Project (3GPP), Long Term Evolution (LTE), 5th Generation (5G) and/or New Radio (NR), may be used in this disclosure, this should not be seen as limiting the scope of the disclosure to only the aforementioned system. Other wireless systems, including without limitation 3GPP 6th Generation (6G) or later, Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by any single node described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

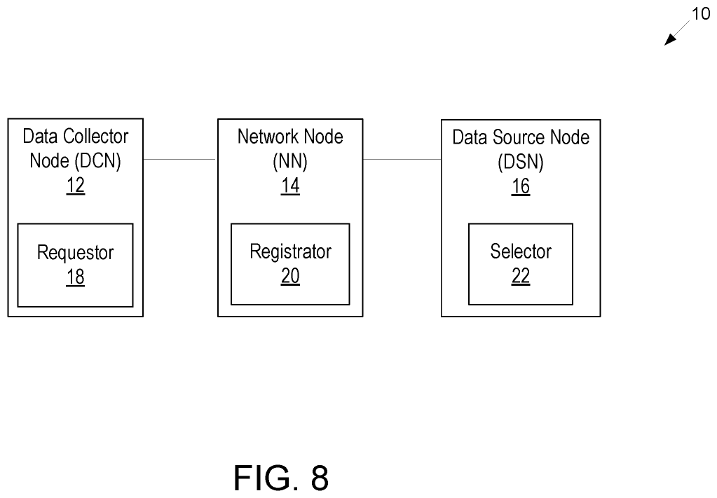

Referring again to the drawing figures, in which like elements are referred to by like reference numerals, there is shown in FIG. 8 a schematic diagram of the system 10, according to one embodiment, constructed in accordance with the principles of the present disclosure. The system 10 in FIG. 8 is a non-limiting example and other embodiments of the present disclosure may be implemented by one or more other systems and/or networks. Referring to FIG. 8, system 10 includes a data collector node (DCN, e.g., DCCF) 12, a network node (NN, e.g., UDM/NRF) 14 and a data source node (DSN, e.g., data source NF such as an AMF) 16.

It should be understood that the system 10 may include numerous nodes of those shown in FIG. 8, as well as, additional nodes not shown in FIG. 8. In addition, the system 10 may include many more connections/interfaces than those shown in FIG. 8. The system 10 may include one or more nodes having a requestor 18, a registrator 20 and a selector 22.

In some embodiments, a DCN 12 includes the requestor 18 which is configured to initiate data collection coordination for a data source node (DSN), the initiating comprising at least one of: sending a request to a network node to register with the network node as a data collection coordinator for the DSN; and subscribing to the DSN to initiate data collection from the DSN; and optionally, receive data associated with the DSN based on whether the DSN is associated with a second DCN and/or any other DCN.

In some embodiments, NN 14 includes the registrator 20 which is configured to receive a request from a data collector node (DCN) to register with the network node as a data collection coordinator for a data source node (DSN); and determine whether the DSN is associated with a second DCN and/or any other DCN.

In some embodiments, a DSN 16 includes the selector 22 which is configured to receive a subscription from a first data collector node (DCN) to initiate data collection from the DSN; and determine whether the DSN is associated with a second DCN and/or any other DCN.

Some embodiments may include providing the collected data to a consumer node 24.

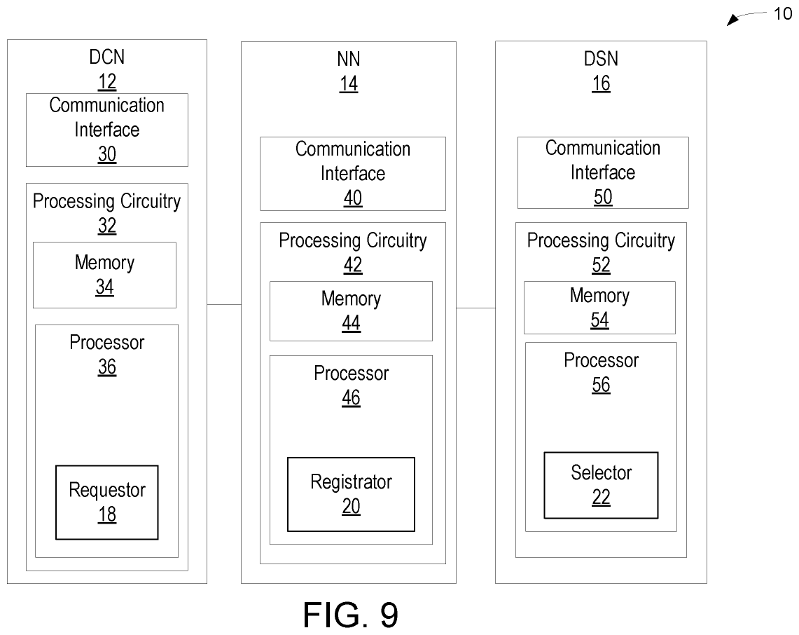

Example implementations, in accordance with some embodiments, of a DCN 12, a NN 14 and a DSN 16, will now be described with reference to FIG. 9.

The DCN 12 includes a communication interface 30, processing circuitry 32, and memory 34. The communication interface 30 may be configured to communicate with any of the nodes in the system 10 (e.g., other DCN 12, NN 14, DSN 16) according to some embodiments of the present disclosure. In some embodiments, the communication interface 30 may be formed as or may include, for example, one or more radio frequency (RF) transmitters, one or more RF receivers, and/or one or more RF transceivers, and/or may be considered a radio interface. In some embodiments, the communication interface 30 may also include a wired interface.

The processing circuitry 32 may include one or more processors 36 and memory, such as, the memory 34. In particular, in addition to a traditional processor and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 34, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the DCN 12 may further include software stored internally in, for example, memory 34, or stored in external memory (e.g., database) accessible by the DCN 12 via an external connection. The software may be executable by the processing circuitry 32. The processing circuitry 32 may be configured to control any of the methods and/or processes described herein and/or to cause such methods, and/or processes to be performed, e.g., DCN 12. The memory 34 is configured to store data, programmatic software code and/or other information described herein. In some embodiments, the software may include instructions stored in memory 34 that, when executed by the processor 36 and/or requestor 18 causes the processing circuitry 32 and/or configures the DCN 12 to perform one or more of the processes described herein with respect to a DCN 12.

The NN 14 includes a communication interface 40, processing circuitry 42, and memory 44. The communication interface 40 may be configured to communicate with any of the nodes in the system 10 (e.g., DCN 12, other NN 14, DSN 16) according to some embodiments of the present disclosure. In some embodiments, the communication interface 40 may be formed as or may include, for example, one or more radio frequency (RF) transmitters, one or more RF receivers, and/or one or more RF transceivers, and/or may be considered a radio interface. In some embodiments, the communication interface 40 may also include a wired interface.

The processing circuitry 42 may include one or more processors 46 and memory, such as, the memory 44. In particular, in addition to a traditional processor and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 46 may be configured to access (e.g., write to and/or read from) the memory 44, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the NN 14 may further include software stored internally in, for example, memory 44, or stored in external memory (e.g., database) accessible by the NN 14 via an external connection. The software may be executable by the processing circuitry 42. The processing circuitry 42 may be configured to control any of the methods and/or processes described herein and/or to cause such methods, and/or processes to be performed, e.g., NN 14. The memory 44 is configured to store data, programmatic software code and/or other information described herein. In some embodiments, the software may include instructions stored in memory 44 that, when executed by the processor 46 and/or registrator 20 causes the processing circuitry 42 and/or configures the NN 14 to perform one or more of the processes described herein with respect to a NN 14.

The DSN 16 includes a communication interface 50, processing circuitry 52, and memory 54. The communication interface 50 may be configured to communicate with the UE and/or other elements in the system 10 (e.g., DCN 12, NN 14, other DSN 16) according to some embodiments of the present disclosure. In some embodiments, the communication interface 50 may be formed as or may include, for example, one or more radio frequency (RF) transmitters, one or more RF receivers, and/or one or more RF transceivers, and/or may be considered a radio interface. In some embodiments, the communication interface 50 may also include a wired interface.

The processing circuitry 52 may include one or more processors 56 and memory, such as, the memory 54. In particular, in addition to a traditional processor and memory, the processing circuitry 52 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 56 may be configured to access (e.g., write to and/or read from) the memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the DSN 16 may further include software stored internally in, for example, memory 54, or stored in external memory (e.g., database) accessible by the DSN 16 via an external connection. The software may be executable by the processing circuitry 52. The processing circuitry 52 may be configured to control any of the methods and/or processes described herein and/or to cause such methods, and/or processes to be performed, e.g., by the DSN 16. The memory 54 is configured to store data, programmatic software code and/or other information described herein. In some embodiments, the software may include instructions stored in memory 54 that, when executed by the processor 56 and/or selector 22, causes the processing circuitry 52 and/or configures the DSN 16 to perform the processes described herein with respect to the DSN 16. In some embodiments, DSN 16 may be and/or comprise and/or implement a single NF instance represented by a NF ID. DSN 16 may be and/or comprise and/or implement a set of NF instances represented by a NF set ID and/or NF type

In FIG. 9, the connection between the devices is shown without explicit reference to any intermediary devices or connections. However, it should be understood that intermediary devices and/or connections may exist between these devices, although not explicitly shown.

Although FIG. 9 shows requestor 18, registrator 20 and selector 22, as being within a respective processor, it is contemplated that these elements may be implemented such that a portion of the elements is stored in a corresponding memory within the processing circuitry. In other words, the elements may be implemented in hardware or in a combination of hardware and software within the processing circuitry.

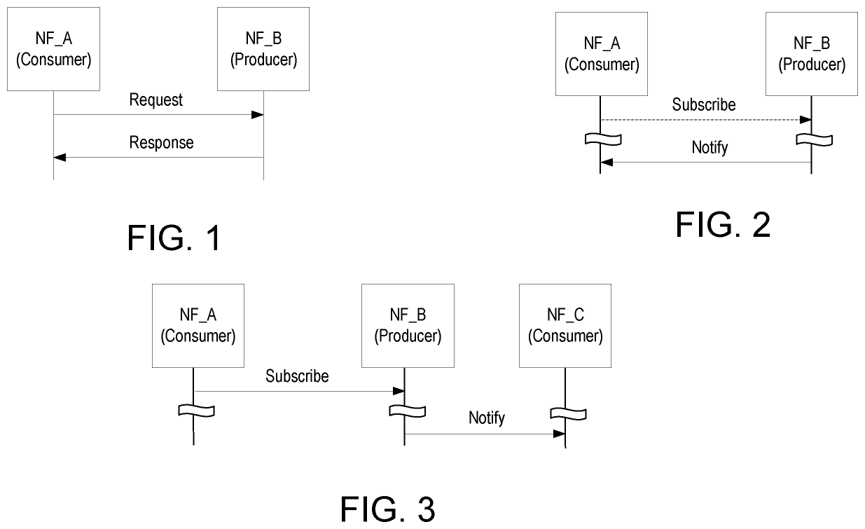

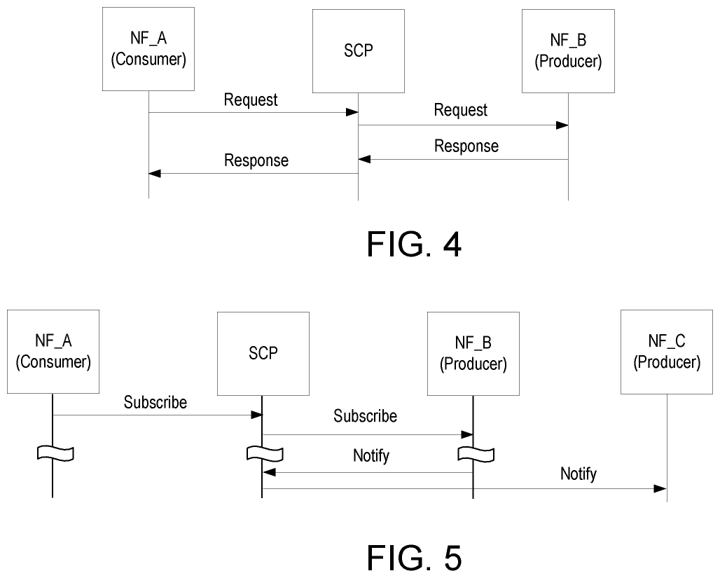

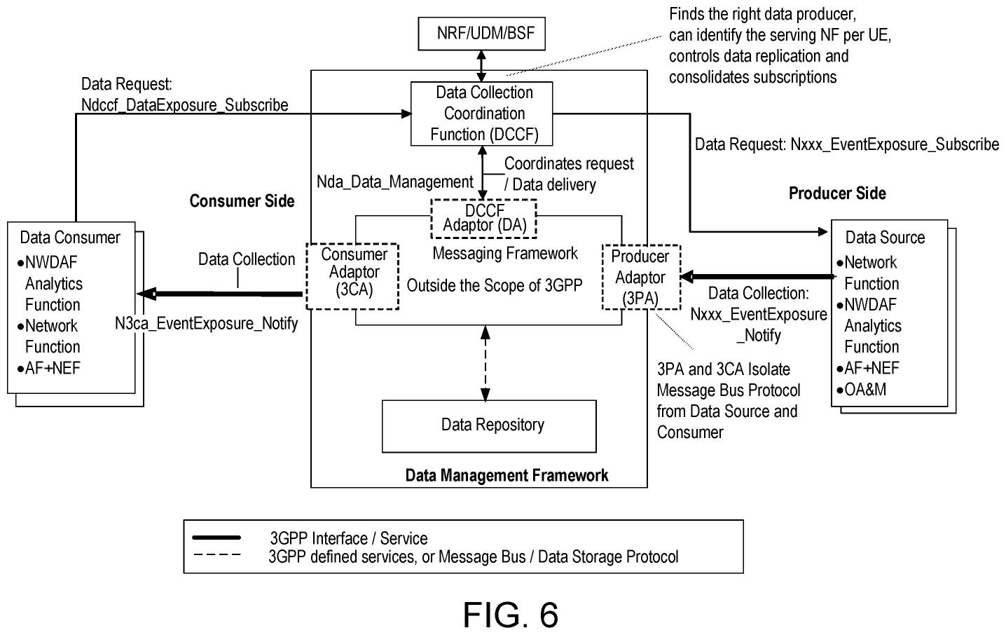

In some embodiments, the inner workings of a DCN 12, a NN 14 and a DSN 16 from FIG. 9 may be as shown in FIG. 9 and independently, the surrounding network topology may be that of any of FIGS. 1-8.

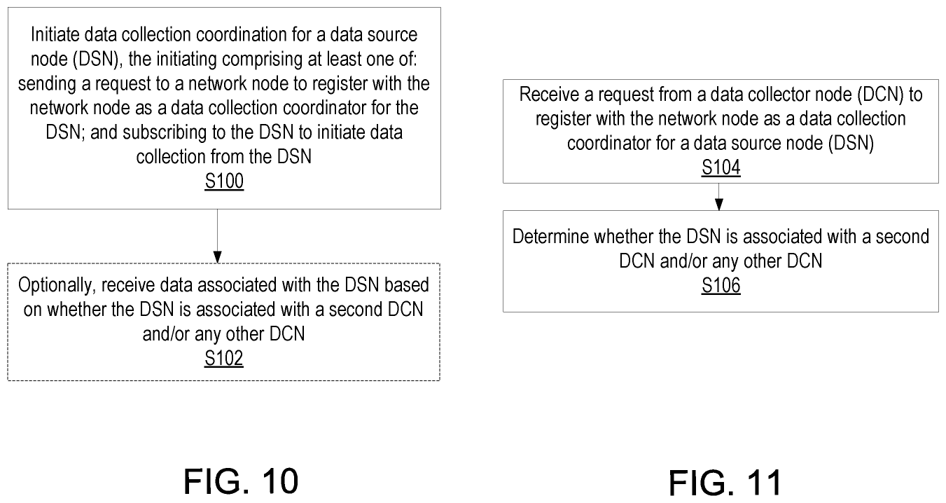

FIG. 10 is a flowchart of an example process according to some embodiments of the present disclosure. One or more Blocks and/or functions and/or methods performed by the DCN 12 may be performed by one or more elements of DCN 12 such as by requestor 18 in processing circuitry 32, memory 34, processor 36, communication interface 30, etc. according to the example process/method. The example process includes initiating (Block S100), such as via requestor 18, processing circuitry 32, memory 34, processor 36, and/or communication interface 30, data collection coordination for a data source node (DSN), the initiating comprising at least one of: sending, such as via requestor 18, processing circuitry 32, memory 34, processor 36, and/or communication interface 30, a request to a network node to register with the network node as a data collection coordinator for the DSN; and subscribing, such as via requestor 18, processing circuitry 32, memory 34, processor 36, and/or communication interface 30, to the DSN to initiate data collection from the DSN. The method includes optionally, receiving (Block S102), such as via requestor 18, processing circuitry 32, memory 34, processor 36, and/or communication interface 30, data associated with the DSN based on whether the DSN is associated with a second DCN and/or any other DCN.

In some embodiments, the request comprises an identification of the DSN; the network node comprises one of a UDM and an NRF and a BSF. In some embodiments, when the DSN is associated with a second DCN and/or any other DCN, at least one of: receiving, such as via requestor 18, processing circuitry 32, memory 34, processor 36, and/or communication interface 30, a notification about the association of the DSN to the second DCN and/or a decline to the request and/or a response comprising an identification of the second DCN and/or using, such as via requestor 18, processing circuitry 32, memory 34, processor 36, and/or communication interface 30, the identification of the second DCN to subscribe to the second DCN; otherwise, receiving, such as via requestor 18, processing circuitry 32, memory 34, processor 36, and/or communication interface 30, a registration response from the network node indicating registration of the DCN as the data collection coordinator for the DSN.

In some embodiments, the identification comprises at least one of a network function (NF) instance identifier (ID), an Internet Protocol (IP) address, a medium access control (MAC) address, etc.

FIG. 11 is a flowchart of an example process according to some embodiments of the present disclosure. One or more Blocks and/or functions and/or methods performed by the NN 14 may be performed by one or more elements of the NN 14 such as by registrator 20 in processing circuitry 42, memory 44, processor 46, communication interface 40, etc. according to the example process/method. The example process includes receiving (Block S104), such as via registrator 20, processing circuitry 42, memory 44, processor 46, and/or communication interface 40, a request from a data collector node (DCN) to register with the network node as a data collection coordinator for a data source node (DSN). The method includes determining (Block S106), such as via registrator 20, processing circuitry 42, memory 44, processor 46, and/or communication interface 40, whether the DSN is associated with a second DCN and/or any other DCN.

In some embodiments, the request comprises an identification for the DSN. In some embodiments, the network node comprises one of a UDM and an NRF and a BSF. In some embodiments, when the DSN is associated with the second DCN, at least one of: notifying, such as via registrator 20, processing circuitry 42, memory 44, processor 46, and/or communication interface 40, the requesting DCN about the association of the DSN to the second DCN and/or declining, such as via registrator 20, processing circuitry 42, memory 44, processor 46, and/or communication interface 40, the request and/or sending, such as via registrator 20, processing circuitry 42, memory 44, processor 46, and/or communication interface 40, a response to the requesting DCN comprising an identification for the second DCN; otherwise, registering, such as via registrator 20, processing circuitry 42, memory 44, processor 46, and/or communication interface 40, the requesting DCN and maintaining an association between the requesting DCN and the DSN.

In some embodiments, the identification comprises at least one of a network function (NF) instance identifier (ID), an Internet Protocol (IP) address, a medium access control (MAC) address, etc.

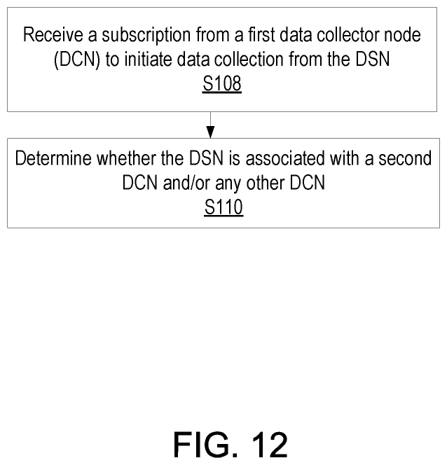

FIG. 12 is a flowchart of an example process according to some embodiments of the present disclosure. One or more Blocks and/or functions and/or methods performed by the DSN 16 may be performed by one or more elements of DSN 16 such as selector 22 in processing circuitry 52, memory 54, processor 56, communication interface 50, etc. according to the example process/method. The example process includes receiving (Block S108), such as via selector 22, processing circuitry 52, memory 54, processor 56, communication interface 50, a subscription from a first data collector node (DCN) to initiate data collection from the DSN. The method includes determining (Block S110), such as via selector 22, processing circuitry 52, memory 54, processor 56, communication interface 50, whether the DSN is associated with a second DCN and/or any other DCN.

In some embodiments, when the DSN is associated with the second DCN and/or any other DCN, at least one of: notifying, such as via selector 22, processing circuitry 52, memory 54, processor 56, communication interface 50, the first DCN about the association of the DSN to the second DCN and/or declining, such as via selector 22, processing circuitry 52, memory 54, processor 56, communication interface 50, the subscription and/or sending, such as via selector 22, processing circuitry 52, memory 54, processor 56, communication interface 50, a response to the first DCN comprising an identification of the second DCN and/or using, such as via selector 22, processing circuitry 52, memory 54, processor 56, communication interface 50, the identification of the second DCN to subscribe to the second DCN; otherwise, selecting, such as via selector 22, processing circuitry 52, memory 54, processor 56, communication interface 50, the first DCN as a data collection coordinator for the DSN and/or maintaining, such as via selector 22, processing circuitry 52, memory 54, processor 56, communication interface 50, an association between the first DCN and the DSN.

In some embodiments, the identification comprises at least one of a network function (NF) instance identifier (ID), an Internet Protocol (IP) address, a medium access control (MAC) address, etc.

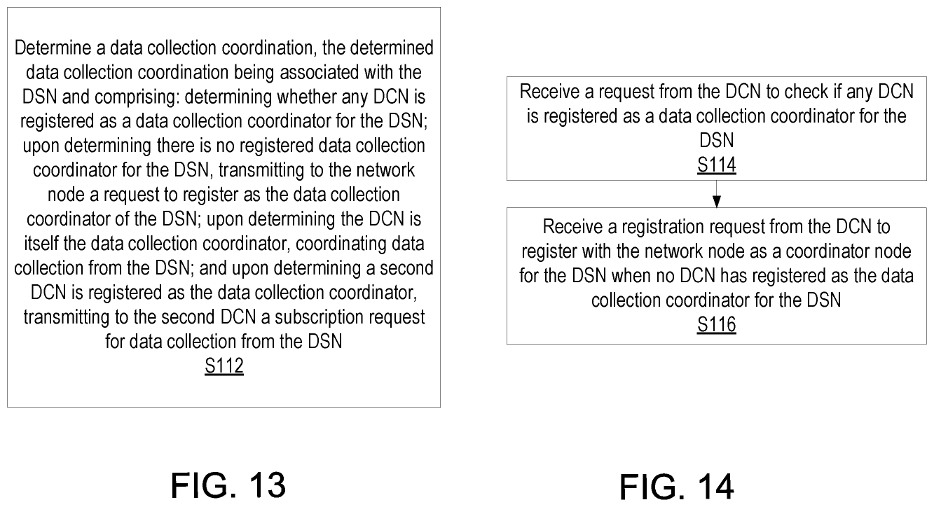

FIG. 13 is a flowchart of an example process (i.e., method) according to some embodiments of the present disclosure. One or more Blocks and/or functions and/or methods performed by the DCN 12 may be performed by one or more elements of DCN 12 such as by requestor 18 in processing circuitry 32, memory 34, processor 36, communication interface 30, etc. according to the example process/method. The example process includes initiating (Block S100), such as via requestor 18, processing circuitry 32, memory 34, processor 36, and/or communication interface 30, determining (S112) a data collection coordination. The determined data collection coordination is associated with the DSN 16 and comprises determining whether any DCN 12 is registered as a data collection coordinator for the DSN 16. Upon determining there is no registered data collection coordinator for the DSN 16, a request to register as the data collection coordinator of the DSN 16 is transmitted to the network node 14. Upon determining the DCN 12 is itself the data collection coordinator, data collection from the DSN 16 is coordinated. Further, upon determining a second DCN is registered as the data collection coordinator, a subscription request for data collection from the DSN 16 is transmitted to the second DCN.

In some embodiments, determining whether any DCN 12 is registered as the data collection coordinator for the DSN 16 comprises transmitting to the network node 14 a request to check if any DCN 12 is registered for the DSN 16.

In some other embodiments, the network node 14 is a node implementing at least one of a user data management function and a network resource function.

In one embodiment, the network node 14 is a node implementing a binding support function (BSF).

In another embodiment, the request to register as the data collection coordinator comprises a first identification of the DSN 16.

In some embodiments, determining the DCN 12 is itself the data collection coordinator comprises receiving a first response from the network node 14 indicating the DCN 12 itself is the data collection coordinator for the DSN 16.

In some other embodiments, the method further comprises receiving from a third DCN a subscription request for data associated with the DSN 16 for which the DCN 12 is the data collection coordinator.

In one embodiment, determining the second DCN is registered as the data collection coordinator comprises receiving a first response from the network node 14 indicating the second DCN is the data collection coordinator for the DSN 16.

In another embodiment, the request to register as the data collection coordinator of the DSN 16 causes a mapping to be maintained at the network node 14. The mapping is between at least one parameter associated with the DCN 12 and at least another parameter associated with the DSN 16.

In some embodiments, the DCN 12 comprises a data collection coordination function (DCCF), the network node 14 comprises a unified data repository, and the DSN 16 comprises a network function (NF).

FIG. 14 is a flowchart of an example process (i.e., method) according to some embodiments of the present disclosure. One or more Blocks and/or functions and/or methods performed by the NN 14 may be performed by one or more elements of the NN 14 such as by registrator 20 in processing circuitry 42, memory 44, processor 46, communication interface 40, etc. according to the example process/method. The example process includes receiving (Block S114), such as via registrator 20, processing circuitry 42, memory 44, processor 46, and/or communication interface 40, a request from the DCN 12 to check if any DCN 12 is registered as a data collection coordinator for the DSN 16; and receiving (S116), such as via registrator 20, processing circuitry 42, memory 44, processor 46, and/or communication interface 40, a registration request from the DCN 12 to register with the network node 14 as a coordinator node for the DSN 16 when no DCN 12 has registered as the data collection coordinator for the DSN 16.

In some embodiments, the method further includes determining whether any DCN 12, including the DCN 12 transmitting the request, is registered as the data collection coordinator for the DSN 16.

In some other embodiments, the request comprises a first identification of the DSN 16.

In one embodiment, the method further includes transmitting a response to the DCN 12 indicating whether one of: no data collection coordinator is registered for the DSN 16; and at least one data collection coordinator is registered for the DSN 16.

In another embodiment, the at least one data collection coordinator indicates the requesting DCN 12 is already the data collection coordinator for the DSN 16.

In some embodiments, the received registration request causes a mapping to be maintained at the network node 14. The mapping is between at least one parameter associated with the DCN 12 and at least another parameter associated with the DSN 16.

In some other embodiments, the at least another parameter associated with the DSN 16 is a first identification of the DSN 16, and the at least one parameter associated with the DCN 12 is a second identification of the DCN 12.

In one embodiment, when the response indicates at least one data collection coordinator is registered for the DSN 16 and the at least one data collection coordinator is a second DCN, the response causes the DCN 12 to transmit to the second DCN a subscription request for data collection from the DSN 16.

In another embodiment, the DCN 12 comprises a data collection coordination function, DCCF, the network node 14 comprises at least one of a unified data management, UDM, a network repository function, NRF, a unified data repository, and a binding support function, BSF, and the DSN 16 comprises a network function.

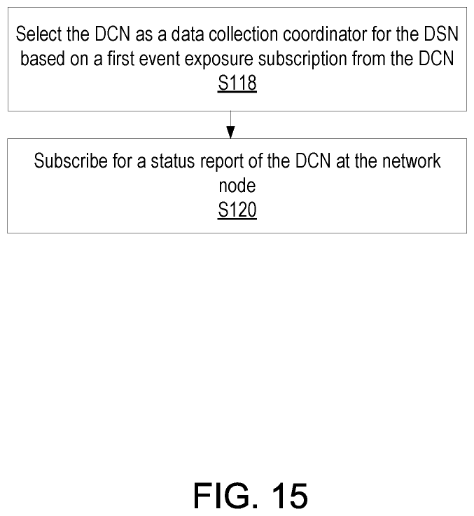

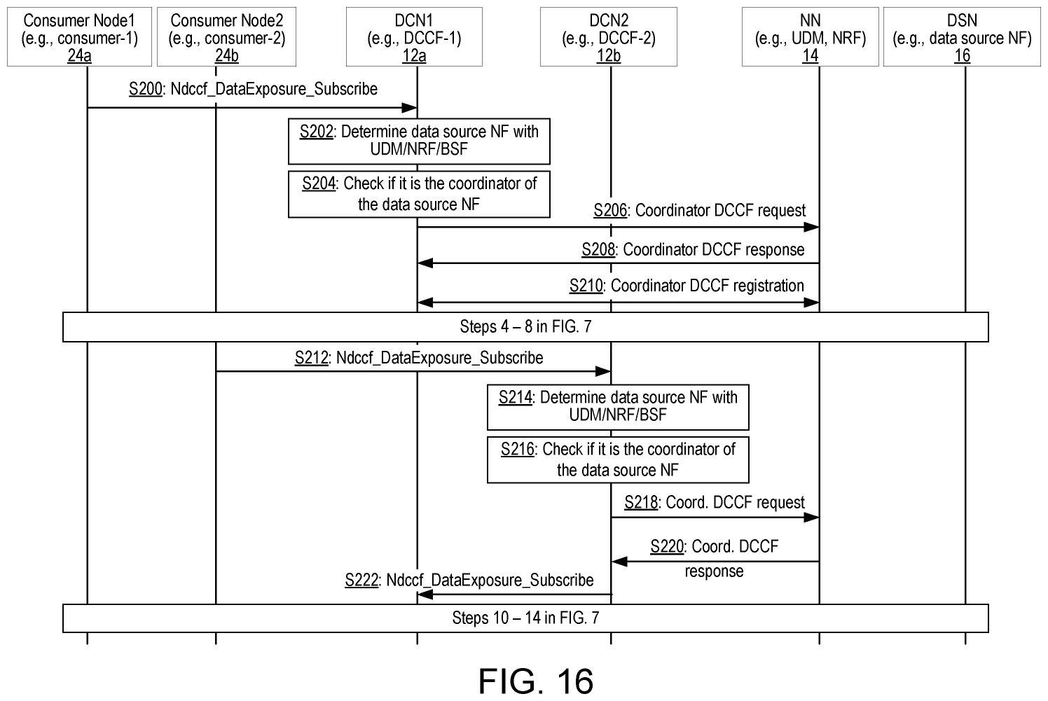

FIG. 15 is a flowchart of an example process (i.e., method) according to some embodiments of the present disclosure. One or more Blocks and/or functions and/or methods performed by the DSN 16 may be performed by one or more elements of DSN 16 such as selector 22 in processing circuitry 52, memory 54, processor 56, communication interface 50, etc. according to the example process/method. The example process includes selecting (Block S118), such as selector 22, processing circuitry 52, memory 54, processor 56, communication interface 50, the DCN 12 as a data collection coordinator for the DSN 16 based on a first event exposure subscription from the DCN 12; and subscribing (Block S120), such as selector 22, processing circuitry 52, memory 54, processor 56, communication interface 50, for a status report of the DCN 12 at the network node 14.

In some embodiments, the method further includes at least one of: transmitting a response based on the first event exposure subscription, where the response indicates the DSN 16 has selected the DCN 12 as the data collection coordinator for the DSN 16; and transmitting another response based on a second event exposure subscription from another DCN when the DCN 12 has already been selected as the data collection coordinator for the DSN 16. The second response indicates the DSN 16 has rejected the second event exposure subscription.

In some other embodiments, the DCN 12 comprises a data collection coordination function DCCF the network node 14 comprises at least one of a unified data management UDM, a network repository function NRF, a unified data repository, and a binding support function BSF, and the DSN 16 comprises a network function (NF).

In one embodiment, the method further includes receiving the first event exposure subscription from the DCN 12; and registering, in the network node 14, the DCN 12 as the data collection coordinator for the DSN 16 when the DSN 16 receives the first event exposure subscription from the DCN 12.

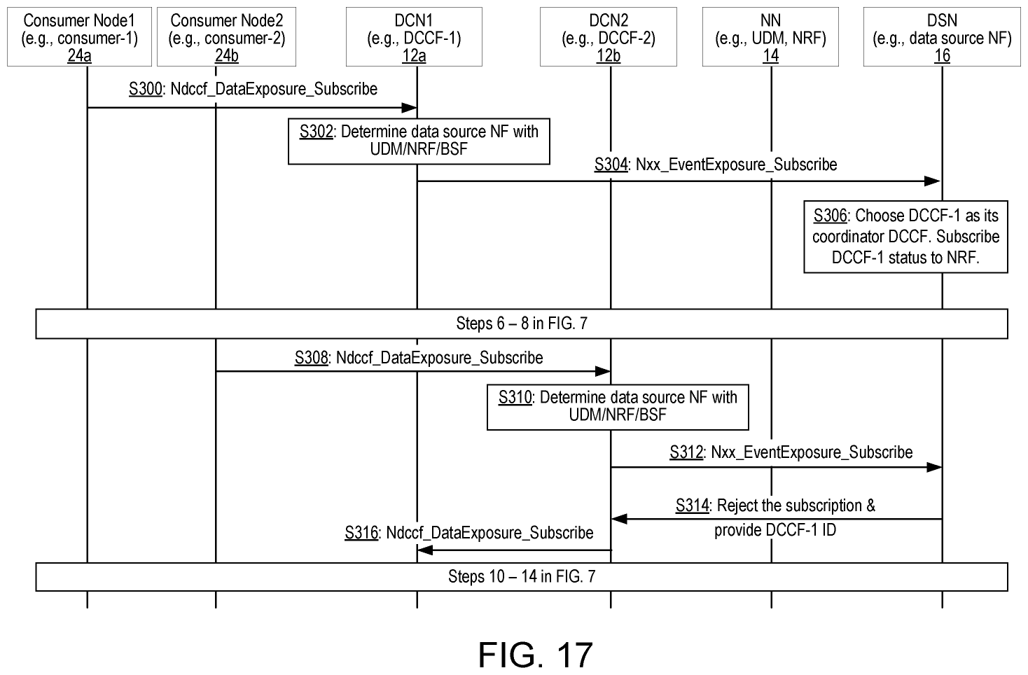

Having generally described arrangements for supporting multiple data DCCF deployment, a more detailed description of some of the embodiments are provided as follows with reference to FIGS. 16 and 17, and which may be implemented by may be implemented by DCN 12 (e.g., such as by requestor 18 in processing circuitry 32, memory 34, processor 36, communication interface 30), NN 14 (e.g., such as via registrator 20, processing circuitry 42, memory 44, processor 46, and/or communication interface 40) and/or DSN 16 (e.g., such as via selector 22, processing circuitry 52, memory 54, processor 56, communication interface 50).

Throughout the nonlimiting examples in this section, the term “DCN 12” may be used as a coordinator DCCF of a specific DSN 16, if the DCCF is coordinating the data collection from that specific DSN 16.

### Dynamic Binding Between DCCFs and Data Source NFs Via UDM/NRF

In this nonlimiting example, there is described a general procedure of dynamic binding between DCCFs and data source NFs via a UDM/NRF. FIG. 16 illustrates an example embodiment, as follows:

Step S200. Consumer Node1 24a (e.g.: NWDAF-1) selects DCN1 12a (e.g., DCCF-1) and sends a request for data to DCN1 12a (e.g., DCCF-1). The message may include the Notification Target Address. The message may indicate whether the requested data is be sent to the Notification Target Address set to Consumer Node1 24a and/or to other Consumers such as Data Repository. The Notification Correlation ID of the Consumer Node1 24a is included in the request message and is used for notifications sent to Consumer Node1 24a.

Step S202. DCN1 12a (e.g., DCCF-1) determines a DSN 16 (e.g., data source NF such as an AMF or NWDAF). If the request is for UE data, DCN1 12a (e.g., DCCF-1) may query the NN 14 (e.g., UDM, NRF, BSF) to determine the NF serving the UE.

Step S204. DCN1 12a (e.g., DCCF-1) determines or checks if itself is the coordinator of the DSN 16 (e.g., data source NF).

Step S206. DCN1 12a (e.g., DCCF-1) determines that itself is not the coordinator DCCF of the DSN 16 (e.g., data source NF); therefore, DCN1 12a sends the coordinator DCCF request to the NN 14 (e.g., UDM, NRF, BSF). In the request, DCN1 12a includes the DSN 16 (e.g., data source NF) ID.

Step S208. In the example, there is no coordinator registered for that DSN 16 (e.g., data source NF). NN 14 (e.g., UDM, NRF, BSF) responds to DCN1 12a (e.g., DCCF-1) that no coordinator is registered yet.

Step S210. DCN1 12a (e.g., DCCF-1) registers itself as the coordinator DCCF of that DSN 16 (e.g., data source NF). NN 14 (e.g., UDM, NRF, BSF) maintains the mapping/relation between the DCN1's 12a (e.g., DCCF-1) NF ID and the DSN's 16 (e.g., data source NF) NF ID.

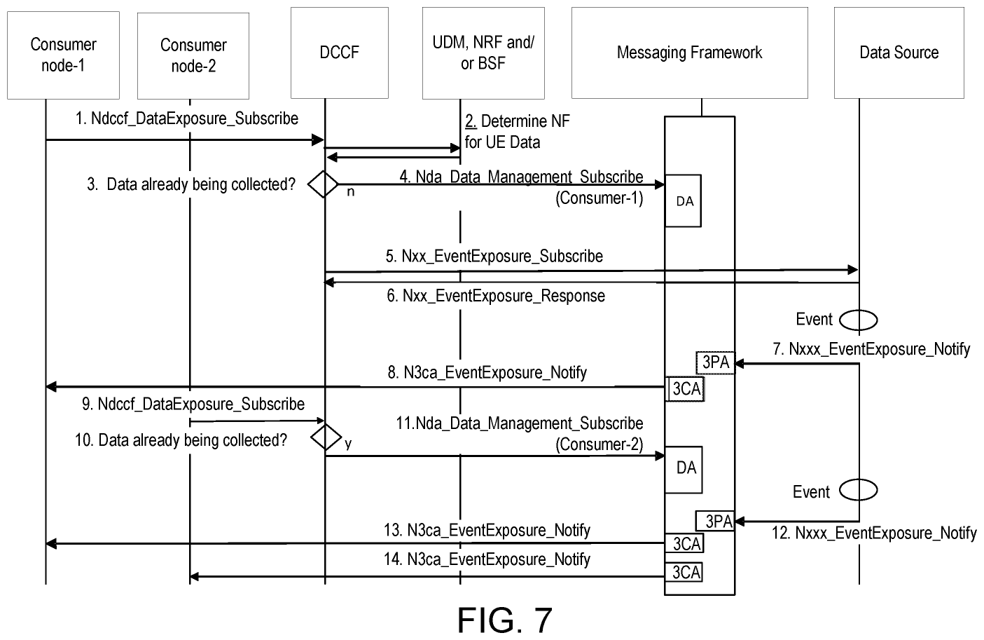

The example embodiment may further include one or more steps corresponding to steps 4-8 in FIG. 7, which are not repeated here for the sake of brevity.

Step S212 of FIG. 16. Consumer Node2 24b (e.g., NWDAF-1) selects DCN212b (e.g., DCCF-2) and sends a request for the same data as consumer-1 to the DCN2 12b. The message includes the Notification Target Address. The message may indicate whether the requested data should be sent to the Notification Target Address set to Consumer Node2 24b and/or to other Consumers such as Data Repository. The Notification Correlation ID of the Consumer-2 is included in the request message and is used for notifications sent to Consumer Node2 24b.

Steps S214 and S216. DCN2 12b determines the same DSN 16 (e.g., data source NF) as DCN1 12a (e.g., DCCF-1) did in step S202 of FIG. 16. DCN2 12b knows it is not the coordinator DCCF of that DSN 16 (e.g., data source NF).

Step S218 and S220. DCN2 12b sends the coordinator DCCF (DCN1 12a in this example) request to NN 14 (e.g., UDM/NRF). In the request, DCN2 12b includes the DSN's 16 (e.g., data source NF) NF ID. NN 14 (e.g., UDM/NRF) responds with the NF ID of DCN1 12a (e.g., DCCF-1).

Step S222. DCN2 12b sends a request for the same data to DCN1 12a (e.g., DCCF-1). In the message, the Notification Target Address and the Notification Correlation ID may be the same as received in step S212 of FIG. 16.

The example embodiment may further include one or more steps corresponding to steps 10-14 in FIG. 7, which are not repeated here for the sake of brevity.

### Data Source NF Chooses Coordinator DCCF

In this nonlimiting example, there is described a general procedure of dynamic binding between DCCFs and data source by providing that the DSN 16 (e.g., data source NF) select the coordinator DCCF. FIG. 17 illustrates the example embodiment, as follows:

Step S300. Consumer Node1 24a (e.g., NWDAF-1) selects DCN1 12a (e.g., DCCF-1) and sends a request for data to DCN1 12a (e.g., DCCF-1). The message includes the Notification Target Address. The message may indicate whether the requested data should be sent to the Notification Target Address set to Consumer Node1 24a and/or to other Consumers such as Data Repository. The Notification Correlation ID of the Consumer-1 is included in the request message and is used for notifications sent to Consumer Node1 24a.

Step S302. DCN1 12a (e.g., DCCF-1) determines the DSN 16 (e.g., data source NF, such as an AMF or NWDAF). If the request is for UE data, DCN1 12a (e.g., DCCF-1) may query the NN 14 (e.g., UDM/NRF/BSF) to determine the NF serving the UE.

Step S304. DCN1 12a (e.g., DCCF-1) sends the event exposure subscription to the DSN 16 to initiate the data collection.

Step S306. The DSN 16 determinates that DCN1 12a (e.g., DCCF-1) is the first DCCF that contacted it (in other words, DSN 16 determinates that it is not associated with any other DCCF). As a result, the DSN 16 (e.g., data source NF) selects DCN1 12a (e.g., DCCF-1) as its coordinator DCCF. The DSN 16 (e.g., data source NF) also subscribes to the status report of DCN1 12a (e.g., DCCF-1) to the NRF via Nnrf_NFManagement_NFStatusSubscribe service. For example, if DCN1 12a (e.g., DCCF-1) is deregistered to the network, the DSN 16 (e.g., data source NF) will get the information and clear its association of coordinator DCCF.

The example embodiment may further include one or more steps corresponding to steps 4-8 in FIG. 7, which are not repeated here for the sake of brevity.

The determination of step S306 may trigger a response (determined/transmitted by the DSN 16) that may indicate DCN1 12a (e.g., DCCF-1) has been selected as the coordinator DCCF. The response may be part of step 6 in FIG. 7. Further, the response may indicate, (e.g., in case of DCCF-2), DCN 12b (e.g., DCCF-2) cannot become the coordinator DCCF for the DSN 16, e.g., because DCN 12a such as DCCF-1 has taken the role of coordinator DCCF (e.g., step 8 in FIG. 7).

Step S308 of FIG. 17. Consumer Node2 24b (e.g.: NWDAF-1) selects DCN2 12b and sends a request for the same data as consumer-1 to the DCN2 12b. The message includes the Notification Target Address. The message may indicate whether the requested data should be sent to the Notification Target Address set to Consumer Node2 24b and/or to other Consumers such as Data Repository. The Notification Correlation ID of the Consumer-2 is included in the request message and is used for notifications sent to Consumer Node2 24b.

Step S310. DCN2 12b determines the DSN 16 (e.g., data source NF, such as an AMF or NWDAF). If the request is for UE data, DCN2 12b may query the NN 14 (e.g., UDM/NRF/BSF) to determine the NF serving the UE.

Step S312. DCN2 12b sends the event exposure subscription to the DSN 16 to initiate the data collection.

Step S314. The DSN 16 (e.g., data source NF) rejects the subscription from DCN2 12b, since DCN1 12a (e.g., DCCF-1) is its coordinator DCCF. DSN 16 provides the ID of DCN1 12a (e.g., DCCF-1) to DCN2 12b.

Step S316. DCN2 12b sends a request for the same data to DCN1 12a (e.g., DCCF-1) using the ID. In the message, the Notification Target Address and the Notification Correlation ID may be the same as received in step 5 of FIG. 17.

The example embodiment may further include one or more steps corresponding to steps 10-14 in FIG. 7, which are not repeated here for the sake of brevity.

The following is a list of nonlimiting example embodiments:

Embodiment A1. A method implemented in a data collector node (DCN), the method comprising:
initiating data collection coordination for a data source node (DSN), the initiating comprising at least one of:
   sending a request to a network node to register with the network node as a data collection coordinator for the DSN; and
   subscribing to the DSN to initiate data collection from the DSN; and
optionally, receiving data associated with the DSN based on whether the DSN is associated with a second DCN and/or any other DCN.

Embodiment A2. The method of Embodiment A1, wherein one or more of:
the request comprises an identification of the DSN;
the network node comprises one of a UDM and an NRF and a BSF; and/or
when the DSN is associated with a second DCN and/or any other DCN, at least one of:
   receiving a notification about the association of the DSN to the second DCN and/or a decline to the request and/or a response comprising an identification of the second DCN and/or using the identification of the second DCN to subscribe to the second DCN;
   otherwise, receiving a registration response from the network node indicating registration of the DCN as the data collection coordinator for the DSN.

Embodiment B1. A data collector node (DCN), the DCN comprising processing circuitry and/or a communication interface, the processing circuitry and/or the communication interface configured to cause the DCN to:
initiate data collection coordination for a data source node (DSN), the initiating comprising at least one of:
   sending a request to a network node to register with the network node as a data collection coordinator for the DSN; and
   subscribing to the DSN to initiate data collection from the DSN; and
optionally, receive data associated with the DSN based on whether the DSN is associated with a second DCN and/or any other DCN.

Embodiment B2. The DCN of Embodiment B1, wherein one or more of:
the request comprises an identification of the DSN;
the network node comprises one of a UDM and an NRF and a BSF; and/or
when the DSN is associated with a second DCN and/or any other DCN, the processing circuitry and/or the communication interface is configured to cause the DCN to at least one of:
   receive a notification about the association of the DSN to the second DCN and/or a decline to the request and/or a response comprising an identification of the second DCN and/or use the identification of the second DCN to subscribe to the second DCN;
   otherwise, the processing circuitry and/or the communication interface is configured to cause the DCN to receive a registration response from the network node indicating registration of the DCN as the data collection coordinator for the DSN.

Embodiment C1. A method implemented in a network node, the method comprising:
receiving a request from a data collector node (DCN) to register with the network node as a data collection coordinator for a data source node (DSN); and
determining whether the DSN is associated with a second DCN and/or any other DCN.

Embodiment C2. The method of Embodiment C1, wherein one or more of:
the request comprises an identification for the DSN;
the network node comprises one of a UDM and an NRF and a BSF; and/or
when the DSN is associated with the second DCN, at least one of:
   notifying the requesting DCN about the association of the DSN to the second DCN and/or declining the request and/or sending a response to the requesting DCN comprising an identification for the second DCN;
otherwise, registering the requesting DCN and maintaining an association between the requesting DCN and the DSN.

Embodiment D1. A network node, the network node comprising processing circuitry and/or a communication interface, the processing circuitry and/or the communication interface configured to cause the network node to:
receive a request from a data collector node (DCN) to register with the network node as a data collection coordinator for a data source node (DSN); and
determine whether the DSN is associated with a second DCN and/or any other DCN.

Embodiment D2. The network node of Embodiment D1, wherein one or more of:
the request comprises an identification for the DSN;
the network node comprises one of a UDM and an NRF and a BSF; and/or
when the DSN is associated with the second DCN, the processing circuitry and/or the communication interface configured to cause the network node to at least one of:
   notify the requesting DCN about the association of the DSN to the second DCN and/or decline the request and/or send a response to the requesting DCN comprising an identification for the second DCN;
otherwise, the processing circuitry and/or the communication interface is configured to cause the network node to register the requesting DCN and maintain an association between the requesting DCN and the DSN.

Embodiment E1. A method implemented in a data source node (DSN), the method comprising:
receiving a subscription from a first data collector node (DCN) to initiate data collection from the DSN; and
determining whether the DSN is associated with a second DCN and/or any other DCN.

Embodiment E2. The method of Embodiment E1, wherein one or more of:
when the DSN is associated with the second DCN and/or any other DCN, at least one of:
notifying the first DCN about the association of the DSN to the second DCN and/or declining the subscription and/or sending a response to the first DCN comprising an identification of the second DCN and/or using the identification of the second DCN to subscribe to the second DCN;
otherwise, selecting the first DCN as a data collection coordinator for the DSN and/or maintaining an association between the first DCN and the DSN.

Embodiment F1. A data source node (DSN), the DSN comprising processing circuitry and/or a communication interface, the processing circuitry and/or the communication interface configured to cause the DSN to:
receive a subscription from a first data collector node (DCN) to initiate data collection from the DSN; and
determine whether the DSN is associated with a second DCN and/or any other DCN.

Embodiment F2. The DSN of Embodiment F1, wherein one or more of:
when the DSN is associated with the second DCN and/or any other DCN, the processing circuitry and/or the communication interface configured to cause the DSN to at least one of:
   notify the first DCN about the association of the DSN to the second DCN and/or decline the subscription and/or send a response to the first DCN comprising an identification of the second DCN and/or use the identification of the second DCN to subscribe to the second DCN;
otherwise, the processing circuitry and/or the communication interface is configured to cause the DSN to select the first DCN as a data collection coordinator for the DSN and/or maintain an association between the first DCN and the DSN.

After that the steps may be the same as steps 10-14 in FIG. 7, which are not repeated here for the sake of brevity.

| Abbreviations | Explanation |
|---|---|
| DCCF | Data Collection Coordination Function |
| DA | DCCF Adaptor |
| 3CA | 3rd party Consumer Adaptor |
| 3PA | 3rd party Producer Adaptor |
| NF | Network Function |
| URI | Universal Resource Identifier |
| REST | Representational state transfer |
| SCP | Service Communication Proxy |

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, may be construed to constitute a complete written description of all combinations and subcombinations of the embodiments described herein, and of the manner and process of making and using them, and may support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a data collector node, DCN, configured to communicate at least with a network node and a data source node, DSN, the method comprising:
determining a data collection coordination, the determined data collection coordination being associated with the DSN and comprising:
determining whether any DCN is registered as a data collection coordinator for the DSN;
upon determining there is no registered data collection coordinator for the DSN, transmitting to the network node a request to register as the data collection coordinator of the DSN;
upon determining the DCN is itself the data collection coordinator, coordinating data collection from the DSN; and
upon determining a second DCN is registered as the data collection coordinator, transmitting to the second DCN a subscription request for data collection from the DSN.

2. The method of claim 1, wherein determining whether any DCN is registered as the data collection coordinator for the DSN comprises transmitting to the network node a request to check if any DCN is registered for the DSN.

3. The method of claim 2, wherein the network node is a node implementing at least one of a user data management function and a network resource function.

4. (canceled)

5. (canceled)

6. The method of claim 2, wherein determining the DCN is itself the data collection coordinator comprises receiving a first response from the network node indicating the DCN itself is the data collection coordinator for the DSN.

7. (canceled)

8. The method of claim 1, wherein determining the second DCN is registered as the data collection coordinator comprises receiving a first response from the network node indicating the second DCN is the data collection coordinator for the DSN.

9. (canceled)

10. The method of claim 1, wherein the DCN comprises a data collection coordination function, DCCF, the network node comprises a unified data repository, and the DSN comprises a network function, NF.

11.-20. (canceled)

21. A method implemented in a network node configured to communicate with at least one data collector node, DCN, the method comprising:
receiving a request from the DCN to check if any DCN is registered as a data collection coordinator for the DSN; and
receiving a registration request from the DCN to register with the network node as a coordinator node for the DSN when no DCN has registered as the data collection coordinator for the DSN.

22. The method of claim 21, further comprising:
determining whether any DCN, including the DCN transmitting the request, is registered as the data collection coordinator for the DSN.

23. (canceled)

24. The method of claim 21, wherein the method further includes:
transmitting a response to the DCN indicating whether one of:
no data collection coordinator is registered for the DSN; and
at least one data collection coordinator is registered for the DSN.

25. The method of claim 24, wherein the at least one data collection coordinator indicates the requesting DCN is already the data collection coordinator for the DSN.

26. The method of claim 21, wherein the received registration request causes a mapping to be maintained at the network node, the mapping being between at least one parameter associated with the DCN and at least another parameter associated with the DSN.

27. The method of claim 26, wherein the at least another parameter associated with the DSN is a first identification of the DSN, and the at least one parameter associated with the DCN is a second identification of the DCN.

28. The method of claim 24, wherein when the response indicates at least one data collection coordinator is registered for the DSN and the at least one data collection coordinator is a second DCN, the response causes the DCN to transmit to the second DCN a subscription request for data collection from the DSN.

29. The method of claim 21, wherein the DCN comprises a data collection coordination function, DCCF, the network node comprises at least one of a unified data management, UDM, a network repository function, NRF, a unified data repository, and a binding support function, BSF, and the DSN comprises a network function.

30.-38. (canceled)

39. A method implemented in a data source node, DSN, the DSN being configured to communicate at least with a data collector node, DCN, and a network node, the method comprising:
selecting the DCN as a data collection coordinator for the DSN based on a first event exposure subscription from the DCN; and
subscribing for a status report of the DCN at the network node.

40. The method of claim 39, wherein the method further includes at least one of:
transmitting a response based on the first event exposure subscription, the response indicating the DSN has selected the DCN as the data collection coordinator for the DSN; and
transmitting another response based on a second event exposure subscription from another DCN when the DCN has already been selected as the data collection coordinator for the DSN, the other response indicating the DSN has rejected the second event exposure subscription.

41. The method of claim 39, wherein the DCN comprises a data collection coordination function, DCCF, the network node comprises at least one of a unified data management, UDM, a network repository function, NRF, a unified data repository, and a binding support function, BSF, and the DSN comprises a network function, NF.

42. The method of claim 39, wherein the method further includes:
receiving the first event exposure subscription from the DCN; and
registering, in the network node, the DCN as the data collection coordinator for the DSN when the DSN receives the first event exposure subscription from the DCN.

43.-46. (canceled)
